(19) United States
(12) Patent Application Publication
(10) Pub. No.: US 2014/0375414 A1
(43) Pub. Date: Dec. 25, 2014

(54) OPEN TYPE STEREOSCOPIC TRIANGLE AMORPHOUS ALLOY WOUND IRON CORE

(71) Applicant: Guangdong Hai Hong Transformer Co., Ltd., Kaiping City (CN)

(72) Inventors: Kaixuan Xu, Kaiping City (CN); Xianqing Guo, Kaiping City (CN)

(21) Appl. No.: 14/372,670

(22) PCT Filed: Jan. 17, 2012
(86) PCT No.: PCT/CN2012/070468

§ 371 Date: Jul. 16, 2014

(51) Int. Cl. H01F 27/25

(52) U.S. Cl. CPC H01F 27/25
USPC 336/233

(57) ABSTRACT

An open type stereoscopic triangle amorphous alloy reel iron core comprises an iron core body wherein a three-phase round core column combined by three identical closed iron core single frames, and the combined round core column is arranged in a stereoscopic equilateral triangle shape. Each iron core single frame comprises iron yokes arranged on an upper end and a lower end of the iron core single frame, the iron yoke on one side of each iron core single frame is provided with an opening, and the iron core single frame can be assembled or disassembled at the opening. By providing the opening, on the iron yoke on one side of each stereoscopic triangle amorphous alloy iron core single frame, coils can be independently wound in the production process of a transformer, and the finished coils are directly sleeved on the three core columns, improving production efficiency and saving production cost.

### FIELD OF THE INVENTION

This invention relates to a transformer wound iron core, specifically an open type stereoscopic triangle amorphous alloy wound core.

### BACKGROUND OF THE INVENTION

Energy saving is an essential national policy of China to construct a conservation-oriented society. Due to the remarkable ability of amorphous alloy transformer to save energy and protect the environment, it has been gradually accepted by the majority of users and becomes an ideal new generation of distribution transformer. Currently, there are two kinds of cores applied in amorphous alloy transformer on the market. One is planar amorphous alloy core; the other, appearing later, is stereoscopic triangle amorphous alloy wound core (see FIG. 1 and FIG. 2).

The cross-section of planar amorphous alloy core shown in FIG. 1 is rectangle. Structurally, the size design of this kind of transformer is prone to be restricted by amorphous alloy sheet width. The design and manufacture are inflexible. It also has other disadvantages, such as heavier overall weight, higher material costs, huger size, longer processing time, weaker ability to withstand short circuit, higher sound level and so on. However, stereoscopic triangle amorphous alloy wound core is a more prominent one. It not only overcomes the limitations of planar amorphous alloy core in material and size, but also reduces the weight and costs. Moreover, it has significant improvement and upgrade in performance, such as stronger ability to withstand short circuit, further reduction of no-load loss and sound level, symmetry of the three-phase circuit, and more stable output. Its single frame is consecutively wound from the inside out with several complete amorphous alloy strips. The whole frame is closed and the end iron yokes are fixed. As a result, production process is relatively complicated since coils are directly wound around columns.

### SUMMARY OF THE INVENTION

To solve technical problems above, this invention presents a new type of open type stereoscopic triangle amorphous alloy wound core.

This invention adopts the following technical solutions:

An open type stereoscopic triangle amorphous alloy wound core, including a core which is comprised of three phase round core columns combined by three identical closed core single frames, and the combined three-phase round core column is arranged in a shape of a 3D equilateral triangle. Each core single frame is comprised of an upper and a lower yoke of the core single frame. The iron yoke on one side of each core single frame is set with an opening, and the core single frame can be assembled or disassembled at the opening.

As a further improvement of the invention, the opening is set in the middle of the iron yoke.

As a further improvement of the invention, the opening is set on the left side of the iron yoke.

As a further improvement of the invention, the opening is set on the right side of the iron yoke.

As a further improvement of the invention, the opening is set on each of the left and the right side of the iron yoke.

As a further improvement of the invention, the core single frames are lapped joint in the opening.

As a further improvement of the invention, the core single frames are butted joint in the opening.

Here is the beneficial effect of this invention. By providing the opening, which can be conveniently opened, on the iron yoke arranged on one side of each stereoscopic triangle amorphous alloy core single frame, coils can be independently wound in the production process of a transformer, and the finished coils are directly set in the three core columns; therefore, the production efficiency is improved and the production cost is saved.

### BRIEF DESCRIPTION OF THE DRAWINGS

A full and enabling discourse of the present invention, integrating the appended figures with the specific embodiment thereof, is set forth in the specification, in which:

FIG. 1 illustrates the structure of planar amorphous alloy core using traditional technique.

FIG. 2 illustrates the structure of stereoscopic triangle amorphous alloy wound core using traditional technique.

FIG. 3 illustrates the structure of the first embodiment of this invention.

FIG. 4 illustrates the structure of the second embodiment of this invention.

FIG. 5 illustrates the structure of the third embodiment of this invention.

FIG. 6 illustrates the structure of the fourth embodiment of this invention.

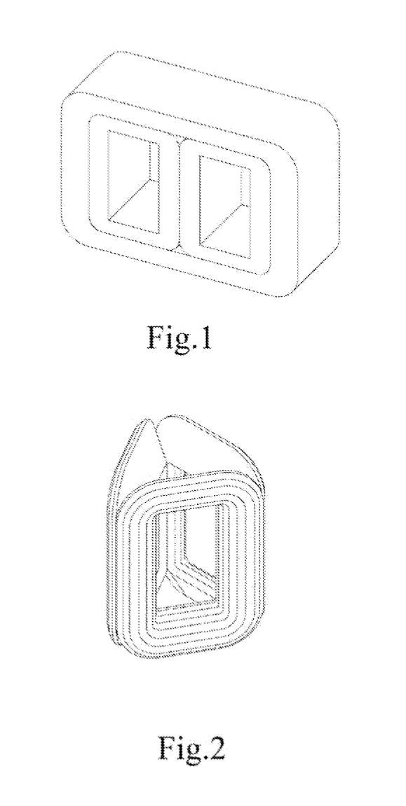

### DETAILED DESCRIPTION

It is an open type stereoscopic triangle amorphous alloy wound core, including a core 1 which core is comprised of three-phase round core columns combined by three identical closed core single frames 2, and the combined three-phase round core column is arranged in a shape of a 3D equilateral triangle. The cross-section of core column is almost circular.

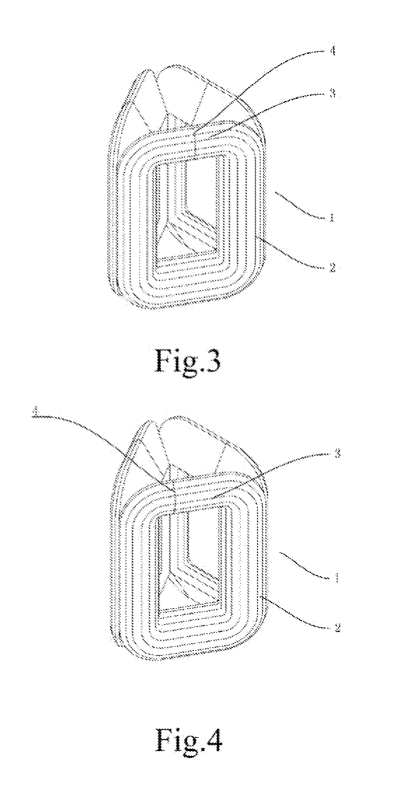

The core single frame 2 is consecutively wound from the inside out with several complete amorphous alloy strips, including iron yokes arranged on an upper and lower end. There is an opening 4 at one end of the iron yoke 3. Opening 4 may be in the middle or at the left or/and the right side of the iron yoke 3. FIG. 3 illustrates the structure of the first improvement of this invention. Opening 4 is only in the middle of the iron yoke 3. And the length of each layer of strips is symmetric by the middle of the iron yoke 3. Thus, two horizontal parts are basically of the same length.

FIG. 4 illustrates the structure of the second embodiment of this invention. Opening 4 is only at the left side of the iron yoke 3. And the length of each layer of strips is not symmetric by the middle of the iron yoke 3. Thus, the left side of the strip is shorter than that of the right side.

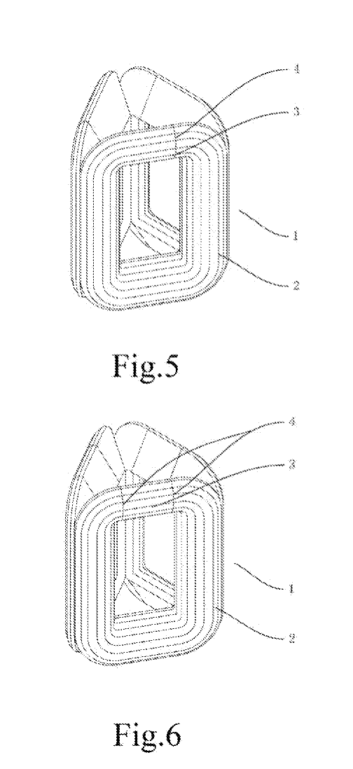

FIG. 5 illustrates the structure of the third embodiment of this invention. Opening 4 is only at the right side of the iron yoke 3. And the length of each layer of strips is not symmetric by the middle of the iron yoke 3. Thus, the left side of the strip is longer than that of the right side.

FIG. 6 illustrates the structure of the fourth embodiment of this invention. Opening 4 is set on each of the left and the right side of the iron yoke 3. The openings of both sides should be opened simultaneously. And the length of each layer of strips is not symmetric by the middle of the iron yoke 3. And each length of strips of both sides of the iron yoke 3 is alternate with each other. Specifically, the long one alternates with the short one at the left side, while the short one alternates with the long one at the right side. Thus, there are totally two openings at the left and the right side of the iron yoke 3.

In all the embodiment s mentioned above, the opening 4 of each layer of strips is in active connection, which may be lapped joint or butted joint. Moreover, each layer could be wound together with single or multiple amorphous alloy strips.

All the embodiments described above are the prior ones. As long as using substantially the same means to achieve the invention, the technical proposal are within the protection scope of the invention.

1-7. (canceled)

8. An open type stereoscopic triangle amorphous alloy reel iron core, including a core which is comprised of three phase round core columns combined by three identical closed core single frames, wherein a combination of the three-phase round core columns is arranged in a shape of a stereoscopic equilateral triangle, comprising:
the core columns that each defining a circular cross-section;
the core single frames each including iron yokes set on an upper end and a lower end of the iron core single frame; and
each of the iron yokes defining one or more openings,
wherein, the core single frame is constructed and arranged to be assembled or disassembled at a respective of the one or more openings, and
wherein the core single frame is consecutively wound from inside out with several complete amorphous alloy strips.

9. The open type stereoscopic triangle amorphous alloy reel iron core of claim 8, wherein the one or more openings is/are set in the middle of the iron yoke, respectively, and a length of each layer of the strips is symmetric by the middle of the iron yoke, whereby two horizontal parts are of approximately a same length.

10. The open type stereoscopic triangle amorphous alloy reel iron core of claim 8, wherein the one or more openings is/are set at a left side of the iron yoke, and a length of each layer of strips is not symmetric by the middle of the iron yoke, whereby a left side of the strip is shorter than that of a right side.

11. The open type stereoscopic triangle amorphous alloy reel iron core of claim 8, wherein the one or more openings is/are set at a right side of the iron yoke, and a length of each layer of strips is not symmetric by the middle of the iron yoke, whereby a left side of the strip is longer than the right side.

12. The open type stereoscopic triangle amorphous alloy reel iron core of claim 8, wherein the one or more openings is/are set on each of a left side and a right side of the iron yoke, wherein the one or more openings of both sides are opened simultaneously and a length of each layer of strips is not symmetric by the middle of the iron yoke, and each length of strips of both sides of the iron yoke is alternate with another layer of the strips.

13. The open type stereoscopic triangle amorphous alloy reel iron core of claim 12, wherein the strips alternate between a short layer of the strips and a long layer of the strips, and wherein the long layer alternates with the short layer at the left side, and the short layer alternates with the long layer at the right side, whereby, there are two openings defined at the left and the right side of the iron yoke.

14. The open type stereoscopic triangle amorphous alloy wound core of claim 8, wherein the core single frames are lapped jointed in the opening.

15. The open type stereoscopic triangle amorphous alloy wound core of claim 8, wherein the core single frames are butted jointed in the opening.
